(19) United States
(12) Patent Application Publication
(10) Pub. No.: US 2017/0270457 A1
(43) Pub. Date: Sep. 21, 2017

(54) PROVIDING AN EMPLOYEE A PERK TO COLLECT DATA OF EMPLOYEE USAGE OF CORPORATE RESOURCES

(71) Applicant: Dell Software, Inc., Round Rock, TX (US)

(72) Inventors: Curtis Johnstone, Ottawa (CA); Michel Albert Brisebois, Renfrew (CA)

(21) Appl. No.: 15/073,154

(22) Filed: Mar. 17, 2016

(51) Int. Cl. G06Q 10/06

(52) U.S. Cl. CPC G06Q 10/063112

(57) ABSTRACT

Systems and techniques are described to display usage data that is collected regarding the employee's use of corporate computing resources and obtain the employee's permission to collect the usage data. A data schema associated with the usage data may be determined. Data elements included in the usage data may be determined based at least in part on the data schema. A permission model associated with the usage data may be determined. Based at least in part on the permission model, one or more additional employees that have access to the usage data may be determined. The employee may use a user interface to display the type of usage data that is being collected and the one or more additional employees that have access to the usage data. The employee may use the user interface to provide permission to collect the type of usage data.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

An employer may collect data associated with employee usage of corporate communication systems. For example, the employer's employment agreement may include a provision whereby employees waive their rights to data privacy in return for employment. Increasingly, courts are determining that such employment agreements do not grant employers carte blanche with regard to the use of employee usage data, particularly where the data includes personally identifiable information.

### SUMMARY

This Summary provides a simplified form of concepts that are further described below in the Detailed Description. This Summary is not intended to identify key or essential features and should therefore not be used for determining or limiting the scope of the claimed subject matter.

Systems and techniques are described to display usage data that is collected regarding the employee's use of corporate computing resources and obtain the employee's permission to collect the usage data. A data schema associated with the usage data may be determined. Data elements included in the usage data may be determined based at least in part on the data schema. A permission model associated with the usage data may be determined. Based at least in part on the permission model, one or more additional employees that have access to the usage data may be determined. The employee may use a user interface to display the type of usage data that is being collected and the one or more additional employees that have access to the usage data. The employee may use the user interface to provide permission to collect the type of usage data.

### BRIEF DESCRIPTION OF THE DRAWINGS

A more complete understanding of the present disclosure may be obtained by reference to the following Detailed Description when taken in conjunction with the accompanying Drawings. In the figures, the left-most digit(s) of a reference number identifies the figure in which the reference number first appears. The same reference numbers in different figures indicate similar or identical items.

FIG. 1 illustrates an example of an architecture in which employee resource usage data is gathered according to some implementations.

FIG. 2 illustrates an example of a system that includes a data collector according to some examples.

FIG. 3 illustrates an example of a system that includes usage data identifying how employees have used corporate resources according to some examples.

FIG. 4 illustrates an example of a system that includes employee resource usage profiles according to some examples.

FIG. 5 illustrates an example of a system that includes an administrator policy configuration console (e.g., user interface) according to some examples.

FIG. 6 illustrates an example of a system that includes an employee privacy management portal (e.g., user interface) according to some examples.

FIG. 7 is a flowchart of a process that includes categorizing data elements in usage data according to some examples.

FIG. 8 is a flowchart of a process that includes displaying additional employees that have access to usage data according to some examples.

FIG. 9 illustrates an example configuration of a computing device that can be used to implement the systems and techniques described herein.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, a touchscreen and/or video display. The information handling system may also include one or more buses operable to transmit communications between the various hardware components.

The techniques and systems described herein provide an approach to the collection and storage of employee usage data that encompasses three aspects. First, software may be used to auto-discover the different types of usage data (e.g., data as to how employees are using resources) being gathered by the enterprise. Second, employees may view which types of usage data are being gathered and may opt-in or opt-out of the gathering of at least some of the different types of usage data. Third, the enterprise may provide some form of a “perk” (e.g., an allocation of enterprise resources that benefit the employee) when an employee chooses to opt-in to the gathering of at least some of the different types of usage data.

The approach described herein informs employees regarding the different types of usage data that is being collected, who has access to the gathered data, and how the gathered data is used. The rights of the enterprise and the rights of the employees may be balanced by reassuring employees that the usage data being collected is used for business purposes. The systems and techniques may (1) discover what types of usage data is being collected and from which systems, and determine who has access to the gathered data (2) provide, to the employee, the information regarding what usage data is being collected and from which systems the information is being gathered and enable the employee to select (e.g., opt-in) as to which types of data will be gathered for the employee and (3) provide incentives to employees to elect to share individual employee usage data. For example, an employee that opts to allow the enterprise to collect usage data associated with a video conferencing application (e.g., Skype® for business) may be permitted to work from home using the video conferencing application. As another example, an employee that opts to allow the enterprise to collect location information (e.g., global positioning system (GPS) data) from a corporate phone may be provided with global access (e.g., global dialing) privileges on the corporate phone.

Enterprise communication systems, such as email servers (e.g., Microsoft® Exchange®), audio and video conferencing servers (e.g., Lync® or Skype® for business), servers that provide enterprise software applications (e.g., Office365®), and communication servers (e.g., Internet Protocol (IP) based phone and messaging system) may collect many different types of data. The different types of data may be stored in different databases. For example, the data many be stored in system logs, performance logs, user account information, authentication and directory services, or the like. A software application, such as Dell® Unified Communications Command Suite (UCCS) may be used to discover the type of usage data that is gathered (e.g., through log access or direct account access). The underlying schemas for the enterprise communication systems may be at a relatively low-level and may be complex. For example, the administrator or the employee may not be capable of fully understanding the ramifications regarding the gathering of low-level data items. A software application, such as UCCS, may enable an administrator or an employee to make sense of the data schemas by indicating what type of information the low-level data items provide. For example, the software application may indicate that a particular data item enables an administrator to determine which external website the employee visited using a web browser.

Thus, the systems and techniques described herein may include an application to discover data schemas used by enterprise systems (e.g., email systems, conferencing systems, software application systems, communication systems, etc.) to determine what types of data are being collected and who has access to the collected data. The systems and techniques described herein may include an employee portal that enables an employee to view what types of data (e.g., associated with how the employee is using corporate resources) are being collected, who has access to the collected data, and to provide (or deny) permission to collect non-mandatory data. The employee portal may communicate the employee's permissions regarding data collection to the appropriate systems in the enterprise. For example, if an employee denies the enterprise permission to gather data regarding how the employee uses a video conferencing application, the employee portal may instruct the video conferencing application to not collect usage data when the employee uses the video conferencing application. The systems and techniques described herein may include a broker application that receives an employee's selections regarding data collection and the employee's requests for resource allocation and automatically (e.g., without human interaction) initiates a request to allocate the requested resources. The broker application may monitor the employee's usage and revoke the allocated resources in response to determining that the employee has breached one or more usage policies.

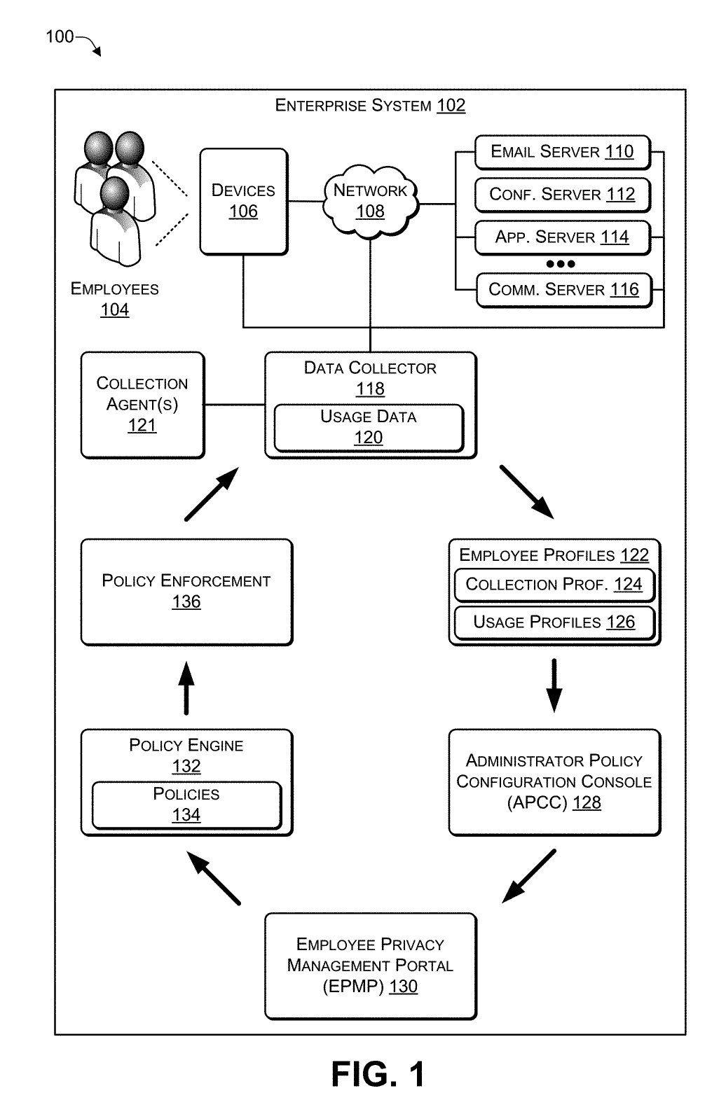

FIG. 1 illustrates an example of an architecture 100 in which employee resource usage data is gathered according to some implementations. The architecture 100 may include an enterprise system 102 used by multiple employees 104. Individual ones of the employees 104 may use one or more devices 106 to access various servers via a network 108. The network 108 may include wired technologies (e.g., Ethernet® and the like) and wireless technologies (e.g., WiFi® and the like). The employees 104 may use the devices 106 to access various servers, such as, for example, an email server 110 (e.g., Exchange®), an audio or video conferencing server 112 (e.g., Lync® or Skype® for business), an application server 114 (e.g., Office365®), a communications server 116 (e.g., a server that provides communications services, such as IP telephony, instant messaging, etc.), another type of enterprise service provider server, or any combination thereof.

A data collector 118 (e.g., a software application) may collect usage data 120 associated with the employees 104 use of corporate resources, such as the network 108 and the servers 110, 112, 114, and 116, storing the usage data 120, and classifying (e.g., using one or more filters) the usage data 120. The data collector 118 may collect the employee usage data 120 from a variety of corporate resources, such as applications, appliances, the devices 106, and the network 108. The usage data 120 may be automatically retrieved from a particular corporate resource by one or more collection agents 121 or the particular corporate resource may automatically send the data to one or more of the collection agents 121. For example, a reporting application may send employee usage reports to the collection agents 121, or the collection agents 121 may retrieve (or request) the data from the reporting application.

Software applications that may be used to collect employee usage data may include Dell® applications, such as Kace®, SonicWall®, Enstratius®, Enterprise Mobility Manager, Credant® Data Protection, UCCS, etc. Of course, other, similar types of applications may be used to gather the employee usage data instead of or in addition to the Dell® applications mentioned. An application, such as Kace®, may determine employee usage information associated with network and internal corporate device usage. An application, such as SonicWall®, may determine firewall information, including which external websites an employee has visited. An application, such as Enstratius®, may provide information associate with employee usage of cloud resources. An application, such as Enterprise Mobility Manager may provide employee usage information associated with bring your own device (BYOD), in which an employee uses a personal device (e.g., a wireless phone, a laptop, a tablet, etc. that was not provided to the employee by the enterprise) to access enterprise resources. An application, such as Credant® Data Protection, may provide employee usage information associated with data accesses, such as a location where data was moved to and when the data was accessed. An application, such as UCCS, may provide employee usage data associated with different types of communications, including email, instant messaging (IM), presence, and conferencing. The employee usage data 120 that is collected may conform to corporate policies and to the informed consent provided by the employee.

One or more employee profiles 122 may be created based on the usage data 120. For example, at least one of the employee profiles 122 may be associated with a particular employee. To illustrate, a collection profile 124 may provide details associated with the types of data that are collected for an employee. Machine learning (or other techniques) may be used to analyze the usage data 120 that has been collected (and classified) to create an employee usage profile 126 for each employee. Each of the usage profiles 126 may describe particular enterprise resources, such as particular devices, particular applications, and particular networks, that a particular employee frequently (e.g., greater than a threshold percentage of time) uses.

TABLE 1
USAGE AND BEHAVIOR PROFILE

| | Usage Data | |
|---|---|---|
| | Category | Description |
| 1 | Device | Types of devices (laptops, desktops, mobile |
| | Usage | and tablets) being used and corresponding |
| | | usage for each type of device |
| 2 | Network | Usage of network connection types (Wi-Fi, |
| | Usage | Wired, Cell Network, External Connection |
| | | Points, etc.) |
| 3 | Security | Credentials and credential usage (e.g., which |
| | Data | Active Directory and credentials were used) |
| 4 | Communication | Use of various forms of communication |
| | Usage | including email, instant messaging, email, |
| | | telephone, conferencing, and external websites |
| | | viewed. Data gathered includes what type of |
| | | communication occurred, who was included in |
| | | the communication, how the communication |
| | | took place, and when the communication took |
| | | place. |
| 5 | Use of | Software applications used and frequency of |
| | Applications | usage |
| 6 | Subject Matter | Profile of employee's skill set, |
| | Expert (SME) | experience, and expertise |
| 7 | Content | Use of content and/or metadata describing |
| | Use | the content |

An example of one of the usage profiles 126 is illustrated in Table 1. Of course, additional categories besides those illustrated may be used to classify the usage data 120. For example, communications may be classified based on whether the communications are internal or external to the corporation, communication with a competitor based on an email domain etc.

An administrator policy configuration console (e.g., user interface) 128 may be provided to enable a system administrator to configure whether data in each category that is being collected is (i) viewable or (ii) editable and whether the employee can consent (e.g., opt-in or opt-out) to the collection of the data. For data that the system administrator has configured to be viewable, the employee may see the usage data that is being gathered for the employee in that data category. For data that the system administrator has configured to be editable, the employee may view and edit (e.g., to make corrections to) the data collected for the employee in the data category. Providing the employee with the ability to view the data that is being collected provides transparency and informed consent. Providing the employee with the ability to edit at least some of the data enables the employee to correct data that the system has mischaracterized. For each data collection and profile category, the system administrator may configure, using the administrator policy configuration console 128, whether the employee may consent to the collection of the data. For example, if the collection of certain categories of data is mandatory, the employee may be provided with information as to why the data collection is mandatory and may not be provided with an option to opt-out of the data collection. For data categories whose collection is not mandatory, the employee may be able to provide (or deny) consent to the data collection. In addition, for data categories whose collection is not mandatory, the employee may be provided with information regarding perks (e.g., benefits, such as access to corporate resources) that are available if the employee consents to the collection of data for a particular category. An example of the administrator policy configuration console 128 for a particular employee, a particular department, or a particular business unit is provided in Table 2.

TABLE 2
POLICY CONFIGURATION USER INTERFACE

| Usage Data | | More | Employee | View- | Edit- |
|---|---|---|---|---|---|
| Category | Description | Info | Consent? | able? | able? |
| Device | Types of devices | Click | YES | YES | YES |
| Usage | (laptops, desktops, | | | | |
| | mobile and tablets) | | | | |
| | being used and | | | | |
| | corresponding usage | | | | |
| | for each type of | | | | |
| | device | | | | |
| Network | Usage of network | Click | NO | YES | YES |
| Usage | connection types | | | | |
| | (Wi-Fi, Wired, Cell | | | | |
| | Network, External | | | | |
| | Connection Points, | | | | |
| | etc.) | | | | |
| Security | Credentials and | Click | NO | YES | NO |
| Data | credential usage | | | | |
| | (e.g., which Active | | | | |
| | Directory and | | | | |
| | credentials were | | | | |
| | used) | | | | |
| Communi- | Use of various forms | Click | YES | YES | NO |
| cation | of communication | | | | |
| Usage | including email, | | | | |
| | instant messaging, | | | | |
| | email, telephone, | | | | |
| | conferencing, and | | | | |
| | external websites | | | | |
| | viewed. Data | | | | |
| | gathered includes | | | | |
| | what type of | | | | |
| | communication | | | | |
| | occurred, who was | | | | |
| | included in the | | | | |
| | communication, how | | | | |
| | the communication | | | | |
| | took place, and when | | | | |
| | the communication | | | | |
| | took place. | | | | |
| Appli- | Software | Click | YES | YES | YES |
| cations | applications used | | | | |
| | and frequency of | | | | |
| | usage | | | | |
| Subject | Profile of | Click | YES | YES | YES |
| Matter | employee's skill set, | | | | |
| Expert | experience, and | | | | |
| (SME) | expertise | | | | |
| Content | Use of content | Click | YES | YES | NO |
| Use | and/or metadata | | | | |
| | describing the | | | | |
| | content | | | | |

An employee privacy management portal (e.g., UI) 130 may enable individual employees to view the employee profiles 122, correct at least some of the information in the employee profiles 122, and provide (or deny) consent to collect particular types of usage data. An employee may use the employee privacy management portal 130 to view the employee profile(s) (e.g., the collection profile 124 and the usage profile 126) associated with the employee. The employee privacy management portal 130 may enable employees to see portions of the employee profiles 122 that the system administrator has designated as viewable. The employee privacy management portal 130 may enable employees to edit portions of the employee profiles 122 that the system administrator has designated as editable. For example, the employee may edit specific parts of a profile to make the profile more accurate. To illustrate, the usage data 120 may indicate that an employee of ABC corporation initiated a communication to XYZ corporation that is a competitor to ABC corporation. The employee may provide information that the communication was to the employee's spouse and therefore the communication should not be classified as a ‘communication with a competitor.’ The system administrator may configure editable data in an employee profile such that any edits made undergo a review process before being approved. For example, the review process to approve an employee edit that a communication not be classified as a ‘communication with a competitor’ may include the employee's manager, a human resources (HR) manager, or both.

The employee privacy management portal 130 may enable employees to provide (or deny) consent to the collection of different types of data identified in the employee's profile. The consent to collect and use specific types of data may enable a corporation (e.g., an enterprise) to collect various types of data and to provide perks, e.g., to grant access to specific resources, based on the employee's consent. For example, if an employee consents to the enterprise collecting and storing external network access information (e.g., the IP address of external locations to which the employee connects), the corporation may grant the employee external access to corporate resources to enable the employee to work from home more often. The employee privacy management portal 130 may enable the employee to determine what resources the employee will be allowed to access in response to the employee consenting to the collection of which types of data. The employee privacy management portal 130 may enable an employee to provide time based consent, e.g., consent to collect a specific type of data for a specified period of time. For example, an employee may grant the corporation permission to collect information on the employee's use of cloud-based resources for a six month period to enable the corporation to gather data for a cloud-based research project.

After the employee profiles 122 have been viewed, edited, and employees have provided consent (e.g., via the employee privacy management portal 130) to the data collection of at least some types of employee usage of corporate resources, a policy engine 132 may create (or configure) one or more corporate policies 134 based on one or more of the edited employee profiles 122. The policy engine 132 may store the policies 134 in a policy data store. The policies 134 may specify the type of access that each employee has to corporate resources and features based on each employee's consent (or denial) to the collection of usage data. For example, the policies 134 created based on the employee profiles 122 may include a policy regarding external access of corporate resources, a policy regarding the use of communication resources (e.g., email, instant messaging, etc.) to communicate with people external to the corporation, a social media access policy regarding accessing social media (e.g., Facebook®, LinkedIn®, Twitter®, etc.) using corporate resources (e.g., devices owned or provided by the enterprise), data loss prevention policies, human resources (HR) policies, ethical wall policies (e.g. the people in the corporation with which the employee is allowed to communicate), another type of corporate resource usage policy, or any combination thereof.

Applications, servers, and other components of the enterprise system 102 may provide employees with access to corporate resources based on the policies 134. For example, employees may be provided with access to corporate resources through the use of various networks (e.g., internal network and external networks) and multiple devices (both corporate devices and employee devices) through the use of multiple credentials. A policy enforcement module 136 may control employee use of corporate resources based on the policies 134, resulting in less risk to the corporation. By enabling employees to view (1) the data being collected, (2) who in the corporation has access to the collected data, and (3) how the collected data may be used, employees can be informed as to the consequences of the employee's usage of resources. When a violation of one of the policies 134 occurs, the policy enforcement module 136 may determine which policy was violated and why the policy was violated. In response to determining a policy violation, the policy enforcement module 136 may determine an audit trail using the usage data 120 (e.g., event logs etc.) stored in the enterprise system 102.

As illustrated by the arrows in FIG. 1, the data collector 118, the employee profiles 122, the administrator policy configuration console 128, the employee privacy management portal 130, the policies 134, and the policy enforcement 136 based on the usage data 120 may be components of an integrated lifecycle approach in which the policies 134 are periodically (e.g., repeatedly) adjusted (e.g., tweaked) and refined.

Thus, an enterprise system 102 may collect data associated with employee usage of corporate resources. The collected usage data may be categorized based on the type of data being collected. The collected usage data may be used to create usage profiles for each employee. An administrator may use a policy configuration UI to select which types (e.g., categories) of collected usage data an employee may view, which types of collected usage data the employee may edit, and the collection of which types of data the employee may opt-in (or opt-out). An employee may use a privacy portal to view the usage data being collected and who in the corporation can view the collected data. The privacy portal may enable the employee to edit at least some of the usage data. The privacy portal may enable the employee to provide (or deny) consent to the collection of at least some of the usage data. After the employee has used the privacy portal to view, edit, and consent to the collection of at least some types of usage data, one or more policies may be created and enforced using a policy enforcement module that monitors the usage data. In this way, the corporation can identify the unauthorized or inappropriate use of corporate resources while providing employees with information regarding usage data that is collected and who has access to the usage data. In addition, the corporation may obtain informed consent from each employee to collect the usage data, thereby satisfying privacy laws.

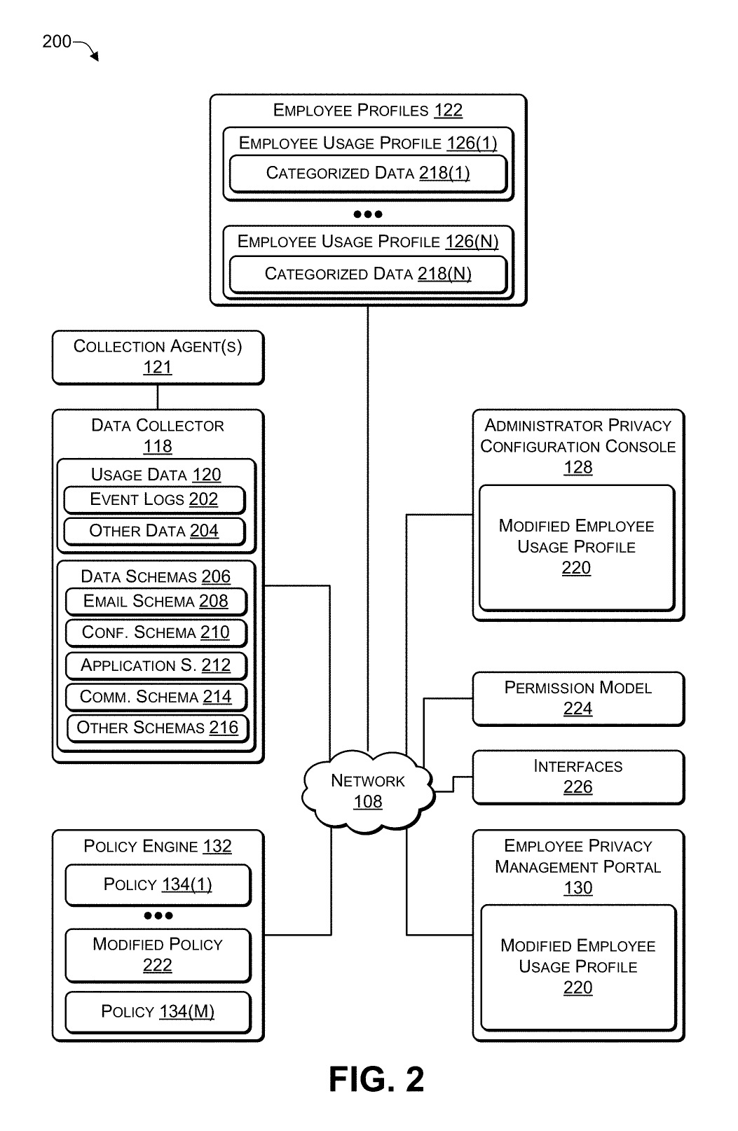

FIG. 2 illustrates an example of a system 200 that includes a data collector according to some examples. One or more of the collection agents 121 may collect usage data 120 for storage by the data collector 118. For example, the collection agents 121 may retrieve at least some of the usage data 120, such as by retrieving event logs 202, from a database in which usage data is stored. The collection agents 121 may send a request for at least some of the usage data 120, such as sending a request to an agent monitoring events associated with a particular component (e.g., workstation, server, database, communications link, firewall, etc.) to provide data associated with usage of the particular component. The collection agents 121 may instruct a network component to periodically send at least a portion of the usage data 120. The usage data 120 may include the event logs 202 and other types of data 204.

One or more data schemas 206 may be used to interpret the information included in the usage data 120, such as an email (e.g., Exchange®, or the like) schema 208, a conferencing (e.g., Lync®, Skype®, or the like) schema 210, a software applications (e.g., Outlook365®, or the like) schema 212, a communications (e.g., IP telephony, messaging, or the like) schema 214, or other (e.g., other types of enterprise resource) schemas 216. At least one of the schemas 208, 210, 212, 214, or 216 may be included in the data collector 118 (e.g., when the data collector 118 is initially installed). The data collector 118 may retrieve (or request) at least one of the schemas 208, 210, 212, 214, or 216 from a component in the enterprise system 102 of FIG. 1. For example, the data collector 118 may retrieve (or request) (i) the email schema 208 from the email server 110, (ii) the conferencing schema 210 from the conferencing server 112, (iii) the application schema 212 from the application server 114, or the communications schema 214 from the communications server 116.

The usage data 120 may be categorized according to the type of usage (e.g., device usage, network usage, security data, communication usage, application usage, content usage, etc.) to create categorized data 218. The categorized data 218 may be stored in the employee profiles 122. For example, a first employee may have an associated employee usage profile 126(1) that includes categorized data 218(1) and an Nth employee (N>1) may have an associated employee usage profile 126(N) that includes categorized data 218(N).

The data schemas 206 may describe details associated with data elements included in the usage data 120, including which data element(s) include user information. For example, one of the event logs 202 may be generated in response to (i) an employee sending an email, (ii) an employee participating in an audio or video conference, (iii) an employee using a software application from a productivity suite, or (iv) an employee receiving or initiating a phone call or instant messaging session. The data schemas 206 may enable the data collector 118 to determine which data element in the event log includes employee information. For example, the email schema 208 may identify, in an event log generated in response to an employee sending an email, a data element identifying the sender of the email. The conference schema 210 may identify, in an event log generated in response to an employee participating in an audio or video conference, a data element identifying each of the participants. The application schema 212 may identify, in an event log generated in response to an employee using a software application, a data element identifying the employee who initiated execution of the software application. The communication schema 214 may identify, in an event log generated in response to an employee receiving or initiating a communication (e.g., a phone call, an instant message, etc.), a data element identifying the person initiating or responding to (e.g., terminating) the communication.

A corporate administrator may use the administrator privacy configuration console 128 to configure what types of usage data individual employees can view, what types of usage data individual employees can edit/correct, and the types of usage data collection to which individual employees can provide (or deny) consent. The corporate administrator may use the administrator privacy configuration console 128 to specify incentives (e.g., perks), such as access to corporate resources, that are provided in exchange for the employee consenting to the collection of certain types of usage data.

A particular employee may use the employee privacy management portal 130 to view collected usage data associated with the particular employee, provide (or deny) permission to collect different types of usage data associated with the particular employee, and optionally edit (e.g., correct) specific data that the system administrator has designated as editable. An employee may use the employee privacy management portal 130 to view incentives (e.g., perks), such as access to corporate resources, that the employee may receive in exchange for the employee consenting to the collection of certain types of usage data.

The policy engine 132 may generate data collection policies, such as the policies 134(1) to 134(M) (M>1), based on the usage data that each employee has consented to being collected. Each corporate resource may use one or more of the policies 134 to determine the resources and data to which an employee has access.

Thus, a system in which employees can view, edit, and provide (or deny) consent to the collection of at least some types of usage data may solve problems that plague conventional privacy and policy management. A first example of a benefit that the systems and techniques described herein may provide (e.g., as compared to a conventional system) is that employees may be provided with the ability to view, edit, and consent to the collection of at least some types of data in exchange for perks, such as access to corporate resources. Consenting to the collection and use of specific types of data may provide an employee with increased privileges in the enterprise. For example, if an employee consents to the collection and use of network access information, such as outside IP addresses from which the employee is connecting to the enterprise network, the employee may be granted remote (e.g., external) access to corporate resources, such as Virtual Private Network (VPN) access. The VPN access may make it easier for the employee to work from home etc. A second example of a benefit that the systems and techniques may provide is transparency and informed consent. Individual employees and the corporation both have a better understanding as to the types of data that may be collected, who in the corporation has access to the collected data, and the types of resource usage policies that the corporation may enforce.

A third example of a benefit that the systems and techniques may provide is better policy enforcement. More granularity in terms of usage data collection and consent may enable the corporation to targeted policy enforcement. A fourth example of a benefit that the systems and techniques provide is improved auditing. For example, when a policy violation is detected, the policy engine 132 may know what usage data to examine to determine additional information about the policy violation. The usage data 120 may include the specific usage data because the usage data 120 that is collected may be collected based on one or more of the employee usage profiles 126 and based on one or more of the policies 134. The usage data 120 enables the policy engine 132 to automatically perform an audit when a policy violation is detected.

A fifth example of a benefit that the systems and techniques may provide includes secure access to corporate resources. A corporation may provide employees with access to more corporate resources using the system and techniques described herein because the granularity of the access can be fine-tuned (e.g. as opposed to an all or nothing approach in a conventional system). For example, if the employee usage profile 126(1) indicates that a first employee has not previously used a virtual private network (VPN) to access one or more corporate resources, the first employee may not be provided with VPN access. In contrast, the employee usage profile 126(N) may indicate that an Nth employee, such as a sales person who travels, frequently uses VPN to access corporate resources. In this example, the Nth employee may be provided with VPN access while the first employee may not be provided VPN access. By not providing VPN access to the first employee, who works in an office environment (e.g., behind a firewall), the corporation avoids exposing potential vulnerabilities associated with the VPN and remote access to corporate resources. VPN access may be provided only to employees whose employee profile indicates frequently accessing corporate resources from a remote location (e.g., outside the corporate firewall).

A sixth example of a benefit that the systems and techniques may provide includes adaptive data privacy and policy management. As illustrated by the arrows in FIG. 1, the policies and privacy management may be repeatedly modified. Thus, the policies and privacy management may become adaptive rather than static because of a lifecycle approach that is based on employee resource usage and informed consent. For example, when an employee changes from a previous position (e.g., sales) that involves travel to a new position (e.g., product manager) that does not involve travel, the employee's corporate resource usage (e.g., one of the employee profiles 122) may cause a change in the employee's policy change and a change in the informed consent agreements. In this example, the employee may have been provided with VPN access in the previous position because the previous position involved travel, resulting in the employee frequently accessing corporate resources remotely using VPN. After changing to the new position, the employee's usage profile may indicate that the employee no longer uses VPN to access corporate resources (e.g., because the employee no longer travels). Based on the employee's usage profile, the system may automatically (e.g., without human interaction) modify the employee's profile to create a modified employee usage profile 220. A system administrator may review (e.g., using the administrator privacy configuration UI) the modified employee usage profile 220 and determine which usage categories are viewable or editable, and the usage data collection to which the employee can provide (or deny) consent. The employee may review (e.g., using the employee privacy management portal) the modified employee usage profile 220, view at least a portion of the collected usage data, edit at least a portion of the collected usage data, and provide (or deny) consent to collect and use at least a portion of the employee's usage data. A modified policy 222 may be created based on the modified employee usage profile 220. The policy engine 132 may enforce the modified policy 222 by, for example, denying the employee (e.g., in the new position) access to corporate resources using VPN or by detecting that the employee accessed corporate resources using VPN and determining that a policy violation occurred.

The data collector 118 may determine a permission model 224, which groups have been defined as having access to which types of data, which employees belong to each group, etc. For example, the permission model 224 may indicate that a manager group has access to usage data associated with employee logins. Thus, if an employee performs a login on a corporate device, the employee's manager (e.g., a member of the manager group) can view usage data that the employee performed a login to a device with a device identifier (e.g., IP address or serial number) XYZ.

The data collector 118 may determine one or more interfaces 226 (e.g., application programming interfaces (APIs) or other interfaces) that enable other systems to access the usage data 120. For example, a payroll system may use an API to access usage data associated with employee logins to enable the payroll system to determine how many hours an employee worked (e.g., a login and corresponding logout may be used to determine the time during which an employee was working). Thus, if an employee performs a login on a corporate device, a member of the payroll department may have access to the login usage data.

The systems and techniques described herein may be used to enforce a variety of corporate policies, such as policies regarding access to social networking sites (e.g., external to the enterprise's network), email and instant messaging policies, communication policies regarding communications with customers, communication policies regarding communications with competitors, policies regarding ethics (e.g., bribery, price fixing, etc.), harassment in the workplace (e.g., communications that include the use of racial slurs, demeaning language, sexual harassment, etc.), intellectual property policies describing how intellectual property may be shared with people and companies external to the enterprise, travel policies that determine how employees may access corporate resources when travelling etc.

The systems and techniques described herein thus encompass three distinct aspects; (1) discovery of usage data that is being collected and who in the organization has access to the collected data, (2) an employee privacy management portal to enable an employee to view the usage data that is being collected for the employee, view who in the organization has access to the collected usage data, provide (or deny) consent to the collection of certain (e.g., non-mandatory) types of usage data, and (3) providing the employee with perks, such as access to corporate resources (e.g., software applications, software tools, data, etc.), based on the types of usage data that the employee has provided consent to the enterprise to collect.

I. Discovering What Data is being Collected & Who has Access

The systems and techniques described herein may use a software application, such as the data collector 118, to determine what type of data is being collected (e.g., in the usage data 120) and determine who has access to the collected usage data 120. The data collector 118 may be capable of identifying and interpreting enterprise system data schemas of common or popular products (e.g., Exchange®, Skype®, Office365®, etc.). For example, the data collector 118, after installation, may include (1) at least one email schema 208, (2) at least one conferencing (e.g., audio and/or video conferencing) schema 210, (3) one or more software application (e.g., word processor application, spreadsheet application, presentation application, etc.) schemas 212, and (4) at least one communications (e.g., IP-based telephony, instant-messaging, etc.) schema 214. The data collector 118 may send queries to various network components to discover permissions (e.g., permission structures, such as groups, members of each group, permissions associated with each group, etc.). The data collector 118 may use the permissions to determine which employees in the enterprise have access to which types of data. For example, all employees belonging to a group X may have Y permissions, enabling each employee in the group X to view resource usage of employees belonging to group Z.

In addition to pre-determined data schemas for common or popular products, the data collector 118 may be capable of determining data schemas that are not included in the data collector 118 (e.g., when the data collector 118 is initially installed). For example, the data collector 118 may import the event logs 202 and correlate them with a known (e.g., pre-determined or pre-installed) data schema. To illustrate, the data collector 118 may include the communications data schema 214 for a Cisco® IP communications (e.g., IP telephony and IP instant messaging) system and may be capable of determining a data schema associated with an Avaya® (or other type of) IP communications system. For example, the data collector 118 may examine Avaya® system logs and compare the Avaya® system logs to Cisco® event logs, a Cisco® data schema, or both to determine what type of employee usage data is being collected by the Avaya® communications system. In this way, the data collector 118 may determine one or more other schemas 216 that were not originally included in the data collector 118.

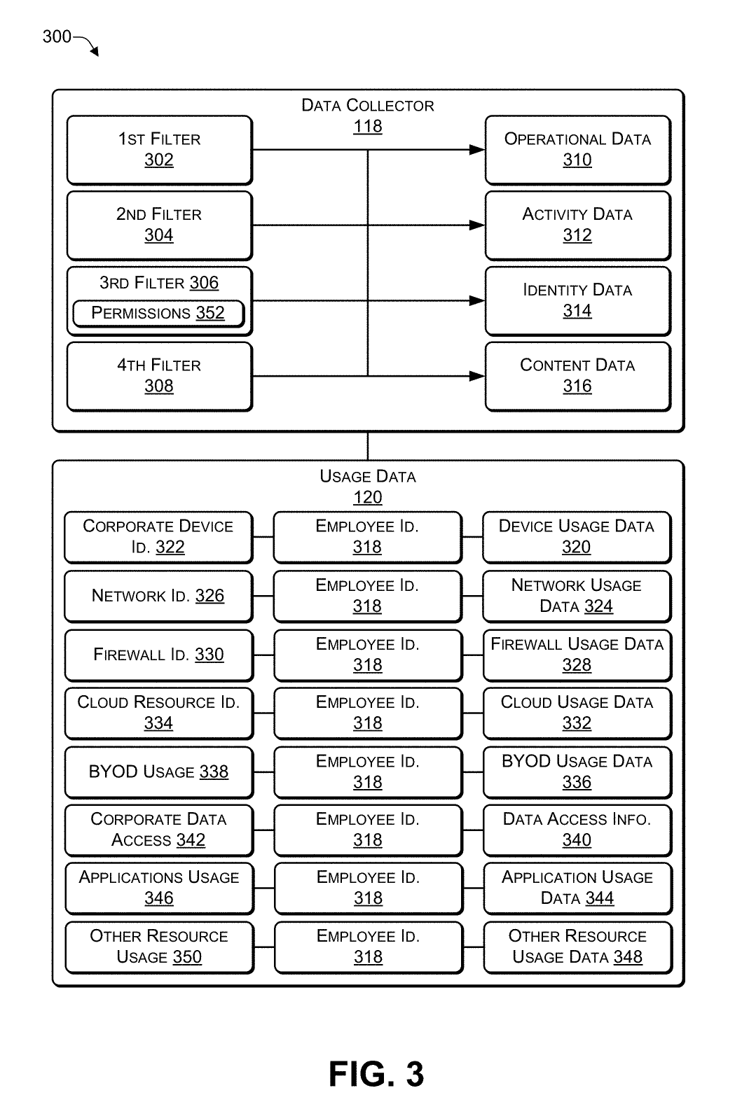

FIG. 3 illustrates an example of a system 300 that includes usage data identifying how employees have used corporate resources according to some examples. The data collector 118 may receive the usage data 120 from multiple collection agents and filter the usage data 120, for each employee, into multiple categories using multiple filters, such as a first filter 302 (e.g., a categorization filter), a second filter 304 (identifiable information filter), a third filter 306 (e.g., permissions mapping filter), and a fourth filter 308 (e.g., access filter).

The first filter 302 may, approximately in real-time, categorize the usage data 120 (e.g., for each employee) into different types of data, such as: (1) operational data 310 (e.g., server hops, timestamps, storage quotas, quality of service (QoS) metrics etc.), (2) activity data 312 (e.g., use of a system component, use of a feature, etc.), (3) identity data 314 (e.g., Active Directory® parameters associated with users, participants in a communication, domains, etc.), and (4) content data 316 (e.g., email content, email attachments, video conference recordings, etc.).

The second filter 304 may, approximately in real-time, determine whether the usage data 120 (e.g., for each employee) includes personally identifiable information (PII). Personally identifiable information may include information (e.g., data elements) that can potentially identify a specific individual (e.g., an employee). Information that may be used to distinguish one person from another person may be considered personally identifiable information. For example, the second real-time filter 304 may determine whether the data includes (1) application usage, (2) data that includes personally identifiable information, (3) aggregated data that does not include personally identifiable information, (4) anonymized data that does not include personally identifiable information, (5) a combination of aggregated data or anonymized data that can lead to determining personally identifiable information, (6) another type of data, or any combination thereof. In terms of determining whether the data includes application usage, while raw application data may be unusable by itself, the second filter 304 may determine whether combining the use of several fields of raw application data may be used to determine personally identifiable information. For example, the second filter 304 may correlate raw application data from multiple tables to determine that a first user initiated a peer-to-peer audio conversation with a second user at 3:30 PM on Tuesday. In this example, a Lync® P2P sessions table may include a first unique identifier (ID) that identifies what types of media streams where used, a second unique ID may link to a table that identifies an employee that originated the communication, and a third unique ID may link to a table that identifies a recipient of the communication. As another example, in Exchange® tracking logs, a raw data record may include a message ID, and the second filter 304 may combine additional raw data records to determine whether the message was sent to an individual, a department, a specific set of individuals, whether the message was an email or a calendar invite, etc.

The third filter 306 may, substantially in real time, map (e.g., correlate) the usage data 120 with permissions data 352 to determine who has access to the usage data 120. For example, the third filter 306 may determine, based on correlating the usage data 120 with permissions data 352, that all employees have access to aggregate data (e.g., parameters A, B, and C) in system X and system Y. As another example, the third filter 306 may determine (e.g., based on correlating the usage data 120 with permissions data 352) that system administrators and human resources directors have access to personally identifiable data in system X. As yet another example, the third filter 306 may determine (e.g., based on correlating the usage data 120 with permissions data 352) that an employee's manager has access to a limited amount of personally identifiable data. As a further example, the third filter 306 may determine (e.g., based on correlating the usage data 120 with permissions data) that the employees that can access data A in system C is unknown (or unascertainable).

The fourth filter 308 may, substantially in real time, discover application programming interfaces (APIs) and other types of interfaces or connections that enable other systems (e.g., analytics, quality monitoring, etc.) to access the usage data 120. Thus, the fourth filter 308 may identify which employees have indirect access (e.g., via an API or other type of interface) to the usage data 120.

The data collector 118 may thus collect the usage data 120 and substantially in real time, for individual employees, determine whether the personally identifiable data associated with the employee is accessible, which employees have direct access to the usage data 120, and which employees have indirect access (e.g., via an API or other interface) to the usage data 120. The data collector 118 may correlate metadata to determine connections between disparate sets of data.

For example, for a particular employee having an employee identifier 318, the data collector 118 may determine that data classified as device usage data 320 indicates that the employee used a corporate device having a corporate device identifier 322 for X minutes to initiate a call to number Y. The data collector 118 may determine that data classified as network usage data 320 indicates that the employee used a corporate network with network identifier 326 to access a resource X. The data collector 118 may determine that data classified as firewall usage data 328 indicates that the employee used a firewall with firewall identifier 330 to access websites X, Y, and Z. The data collector 118 may determine that data classified as cloud usage data 332 indicates that the employee accessed a cloud resource having identifier 334. The data collector 118 may determine that data classified as BYOD usage data 336 indicates a device not provided by or associated with the corporation to perform BYOD usage 338. The data collector 118 may determine that data classified as data access information 340 indicates that the employee performed corporate data access 342. The data collector 118 may determine that data classified as application usage data 344 indicates that the employee used a software application to perform application usage 346. The data collector 118 may determine that data classified as other resource usage data 348 indicates that the employee performed other resource usage 350.

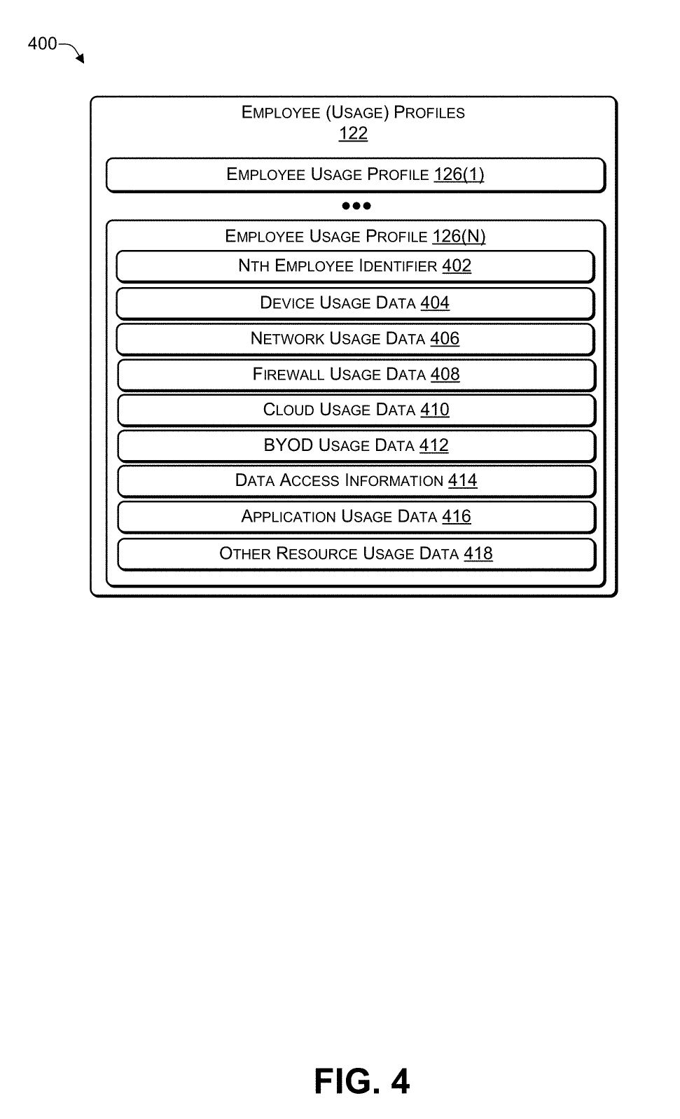

FIG. 4 illustrates an example of a system 400 that includes employee resource usage profiles according to some examples. The employee usage profiles 122 may include the multiple employee usage profile 126(1) to the employee usage profile 126(N) (where N>1 and N is approximately the number of employees in the corporation).

Individual ones of the employee usage profiles 126(1) to 126(N) may include usage data associated with individual employees that has been filtered (e.g., categorized) into multiple usage categories. For example, the employee usage profile 126(N) may include an Nth employee identifier 402, device usage data 404, network usage data 406, firewall usage data 408, cloud usage data 410, BYOD usage data 412, data access information 414, application usage data 416, and other resource usage data 418.

The Nth employee identifier 402 may include data to identify a particular employee, such as, for example, an employee number, a username, an email address, a government issued identifier, another type of employee identifier, or any combination thereof. The device usage data 404 may include information about various corporate devices (e.g., phone, computer, etc.) that the employee has used. For example, the device usage data 404 associated with a phone may include the number of incoming calls received, the number of outgoing calls initiated, the originating number (e.g., address) and the terminating number associated with each call, call duration, number of internal calls (e.g., to employees in the enterprise), number of external calls (to individuals outside the enterprise), etc.

The network usage data 406 may include information regarding which corporate networks (or sub-networks or portions of networks) that the employee accessed. Some corporations may have multiple, distinct networks and the network usage data 406 may identify which of those networks were accessed, the type of access, how often they were accessed, when they were accessed, what credentials were used to access the network, etc.

The firewall usage data 408 may include information collected by a firewall that identifies websites external to the enterprise that the employee accessed. The cloud usage data 410 may include information identifying which cloud-based resources the employee accessed, the type of access, how long each access occurred, the type of operations that were performed in the cloud-based resources, etc. The BYOD usage data 412 may include information regarding the employee's use of non-corporate devices (e.g., personal wireless phone, personal computer, etc.) to access corporate resources. For example, the BYOD usage data 412 may indicate that an employee used a personal device with device identifier X to access the employee's corporate email account via a corporate wireless (e.g., Wi-Fi) network.

The data access information 414 may include information associated with the employee's access of corporate data. For example, the data access information 414 may indicate that the employee accessed sales data for the North American region. The application usage data 416 may identify which software applications (e.g., word processor application, spreadsheet application, presentation application, etc.) the employee used, how long they were used, the actions (e.g., create a file, modify a file, etc.) that the employee used the software application to perform, etc. The other resource usage data 418 may include information associated with the employee's usage of other corporate resources, including which resources were used, how long the resources were used, what actions were performed, etc.

Thus, each employee usage profile may include information filtered based on the type of resource usage. A system administrator may determine the categories used to classify the resource usage. The system administrator may adjust the categories based on the needs of the enterprise. For example, if the enterprise suspects one or more employees of industrial espionage, the system administrator may create categories to provide more information on communications with competitors, etc.

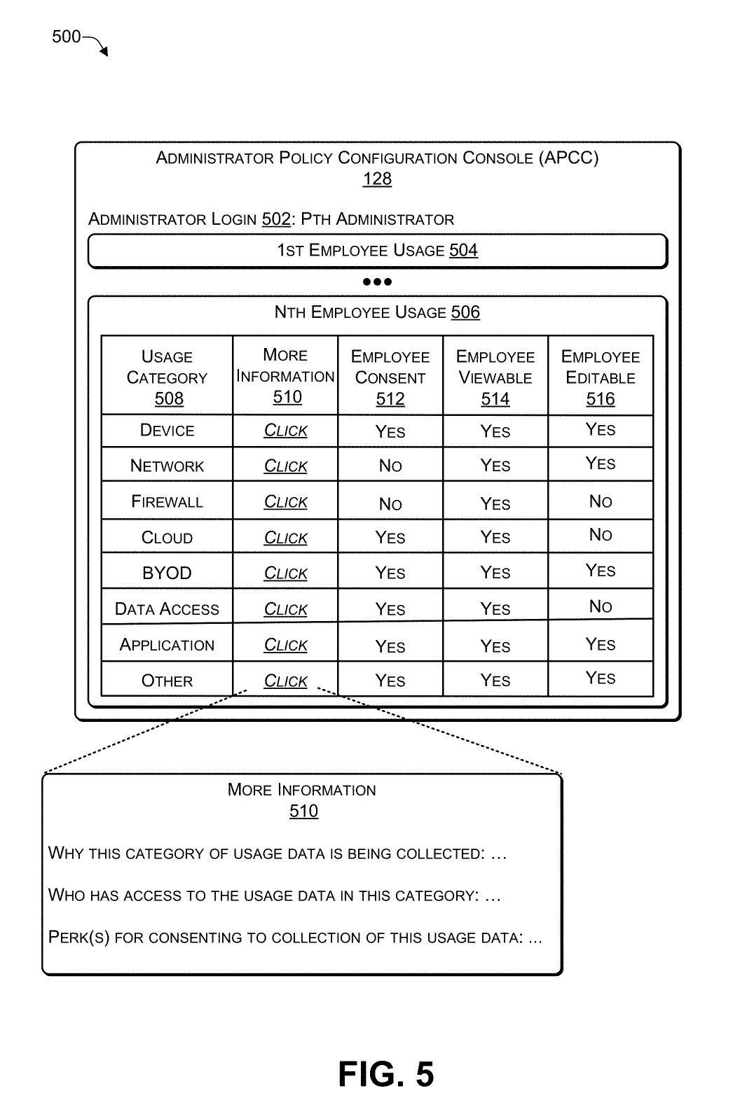

FIG. 5 illustrates an example of a system 500 that includes the administrator policy configuration console (APCC) 128 (e.g., user interface) according to some examples. The APCC 128 may enable an administrator to view the categories for which resource usage information is being gathered and specify (1) the particular categories that are viewable by an employee, (2) the particular categories the employee can edit/correct, (3) whether the employee can consent to the collection of usage data for each category, and (4) additional information, such as why the usage data is being collected (e.g., to comply with Sarbanes-Oxley, to determine inappropriate usage of company resources, etc.), who (e.g., supervisor, manager, vice-president etc.) in the corporation has access to the usage data, perks for consenting to the collection of the usage data, etc.

The APCC 128 may request that an administrator provide credentials to login 502 to the APCC 128. The APCC 128 may include multiple employee usage records, including first employee usage data 504 to Nth employee usage data 506. After login 502, the APCC 128 may enable the administrator to select employee usage data associated with a particular employee. For example, when the administrator selects the Nth employee usage data 506, the administrator can view the different usage categories 508, provide more information 510 regarding each usage category, determine whether to enable the employee to provide employee consent 512, determine whether the usage category is employee viewable 514, and determine whether the data gathered in the usage category is employee editable 516. As an example of the usage categories 508 for which data may be collected, the categories may include device usage, network usage, firewall usage, cloud usage, BYOD usage, data access, application usage, and other resource usage. These categories were described above, e.g., for example, 404, 406, 408, 410, 412, 414, 416, and 418 in the description of FIG. 4.

### II. Employee Privacy Management Portal

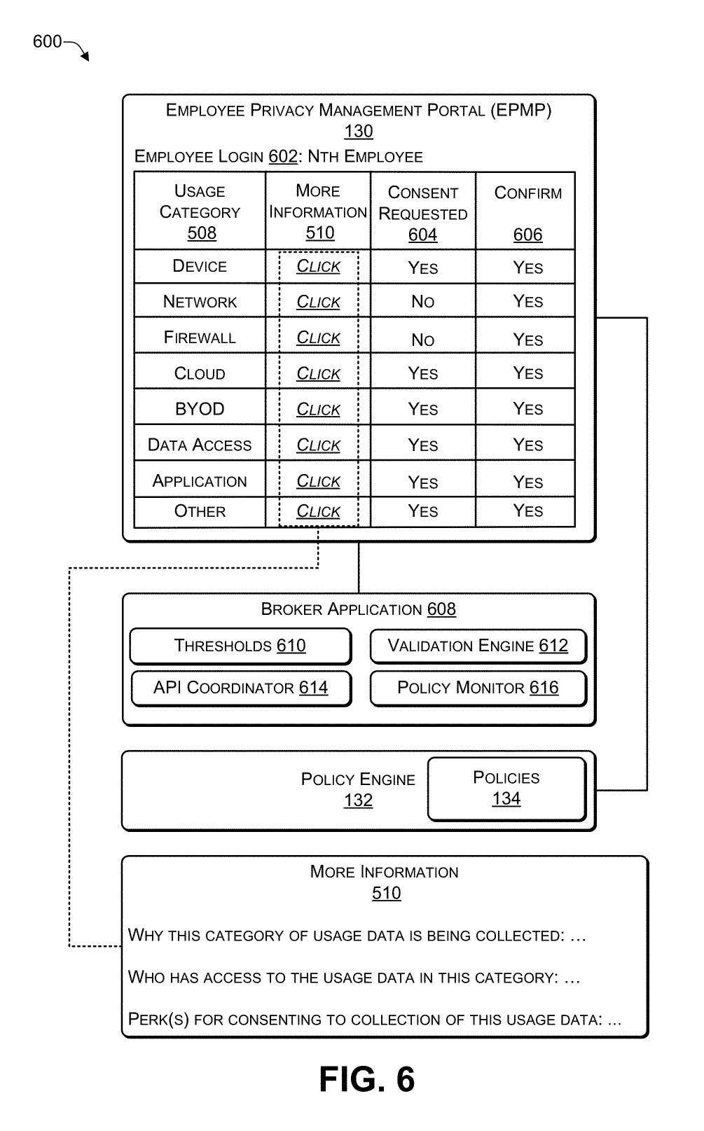

FIG. 6 illustrates an example of a system 600 that includes the employee privacy management portal (EPMP) 130 according to some examples. Each employee may present credentials to perform an employee login 602 to view the usage data being collected, edit some types of data, and provide (or deny) consent to the collection of some types of data. The EPMP 130 may enable individual employees in a corporation to view the types of data (e.g., usage category 508 column) being collected when the employee uses enterprise resources, such as, email, conferencing, software applications, communications, etc. The employee may select a link to obtain more information 510 column, such as why a particular category of usage data is being collected, who has access to the usage data being collected, perks for consenting to collection of a particular type of usage data, etc. The EPMP 130 may identify usage data for which the employee consent 512 column can be provided (or denied), e.g., the consent requested 604 column indicates “yes”. The EPMP 130 may enable the employee to provide consent to the collection of at least some of the usage categories in the usage category 508 column. For example, government (or industry) regulations, such as Sarbanes-Oxley, may mandate that the enterprise collect certain types of usage data (e.g., to provide an audit trail). For data whose collection is mandated, the employee may not be given an option to opt-out (e.g., the consent requested 604 column indicates “no”) of the collection of particular types of data. In such cases, the enterprise may use a scrubbing application to “scrub” the data that is collected to remove any personally identifiable information from the data that is collected, before it is stored. In some cases, the employee may be asked to confirm consent to collect a particular category of usage data in a confirm 606 column. The confirm 606 column may provide a confirmation that the employee consented to the collection of certain categories of usage data.

As previously discussed, the data collector 118 of FIG. 1 may be able to determine data schemas and permission models in the enterprise network 102 to determine what types of usage data are being collected and which individuals have access to the collected usage data. The EPMP 130 may display a user interface that includes information associated with the types of data being collected (e.g., displayed in the usage category 508 column) and who (e.g., supervisor, manager, system administrator, etc.) has access to the collected data (e.g., displayed in the more information 510 column). The EPMP 130 may enable an employee to use the consent requested column 604 to provide (or deny) permission to collect the types of usage data included in the usage category 508. Based on the input provided by the employee, the EPMP 130 may communicate with the appropriate systems in the enterprise to enable collection of particular types of data or stop the collection of other particular types of data.

The EPMP 130 may include (or communicate with) the policy engine 132. The policy engine 132 may include the policies 134 specified by the enterprise regarding the types of usage data that are to be collected (e.g., mandatory) and the types of usage data that are optional (e.g., the employee can provide or deny permission to the corporation collecting the usage data). As previously mentioned, the collection of certain types of usage data may be mandated by state or federal laws or to comply with industry standards.

The EPMP 130 may organize the data being collected into various categories. For example, the employee privacy portal may categorize the employee usage data that is being collected into: (1) operational data (e.g., server hops, timestamps, storage quotas, QoS metrics etc.), (2) activity data (e.g., activities performed by the employee or by applications associated with the employee), (3) identity data, (4) content data (e.g., the content of documents accessed by the employee), (5) raw data that is personally identifiable, (6) aggregated data that is not personally identifiable, (7) anonymized data that is not personally identifiable, (8) a combination of anonymized or aggregated data that can lead to personally identifiable data, (9) user access information, and (10) third party application access. Identity data may be closely associated with user access information. An enterprise that adopts identity management may provision employees and corresponding credentials (e.g., username and password) through standard workflows and governance policies. For example, the enterprise may request that an employee attest to their identity before the employee is granted access to a website, a database, or particular data. The enterprise may periodically or when access to sensitive information is being requested, ask the employee to validate their identity (e.g., a trust certificate type of mechanism for employees). The enterprise may assign role-based identities to employees to simplify and streamline access to corporate resources. For example, an executive in a business unit of an enterprise may have a role-based identity that automatically grants the executive with access to particular corporate resources, such as access to sensitive data or access to particular services. Data associated with user access information may include (1) changes to an employee's profile (e.g., adding different group memberships), (2) activities related to attestation and recertification, and (3) governance policies triggered based on an employee's identity. Access management may use an employee's identity to grant (or revoke) access to data and services. The usage data 120 collected by the architecture 100 may include sites to which an employee is granted access either by a direct permission or by membership in a group with access to the sites. The usage data 120 may include activity logs identifying how often sites are accessed, change logs associated with access (e.g., how many access requests, how many grants, how many revocations, inactivity, etc.). Some third party applications may not be linked to an enterprise's identity management systems (e.g., Active Directory, Identity and Access management, etc.). For example, some third party applications, including Software as a Service (SaaS) products (e.g. Box.net, SalesForce, etc.), may maintain their own access credentials while being run and administered internally to the enterprise. The usage data 120 for third party applications may include how often a third party application is accessed, when the third party application is accessed, session information (e.g., how long was each session), a location from whether the third party application was accessed, etc.

The EPMP 130 may identify, in the more information 510 column, which individual(s) and which group(s) (e.g., supervisor, manager, etc.) have access to the data in each category. The EPMP 130 may indicate which types of data collection are mandatory and which are optional, e.g., using the consent requested 604 column. The EPMP 130 may enable an employee to provide (or deny) permission to the enterprise to collect the different types of data that optionally may be collected. After an employee provides input using the EPMP 130 indicating denial of permission to collect a particular type of usage data, the employee portal may send an API request to a corresponding application that is used to collect the particular type of usage data. For example, after an employee provides permission to collect cloud usage data, the employee portal may send an API request instructing a cloud resource API to collect cloud resource usage data associated with the employee. In some cases, after an employee provides input using the EPMP 130, the EPMP 130 may send a report to a system administrator indicating that employee X denied permission to collect usage data Y.

III. Permission Driven Resource Allocation (e.g. Perks)

As previously described, the systems and techniques described herein may be used to determine what types of data an enterprise is collecting, who has access to the collected data, provide information to each employee regarding the data being collected and access to the collected data, and enable individual employees to provide (or deny) permission to collect non-mandatory (e.g., optional) data. In this way, individual employees may be provided with an opportunity to agree to usage data collection at a granular level.

To provide an incentive to employees to provide the enterprise with permission to collect certain categories of usage data, the systems and techniques described herein may enable the enterprise to provide perks to the employees, such as allocating corporate resources, based on the employees granting permission to collect different categories of usage data. Thus, an employee that provides permission to collect usage data may be provided an allocation of corporate resources. For example, the enterprise may provide the employee with perks, such as remote access to corporate applications, automatic granting of access requests to certain types of stored data, increased access privileges (e.g., read and write access instead of read-only access) to certain types of data, access privileges to higher classifications of data (e.g., access to restricted or confidential data), access to corporate resource from external sites to enable the employee to work from home, etc.

For example, the EPMP 130 may provide information associated with employee consent to collecting usage data to a broker application 608. The broker application 608 may allocate particular corporate resources to an employee in response to determining that the employee has provided permission to collect particular types of usage data. The broker application 608 may manage access to corporate resources and manage the collection of particular types of employee data (e.g., including usage data associated with the corporate systems and with employee-owned device(s) used on the corporate systems).

The broker application 608 may include the following components: (1) one or more resource allowance thresholds 610, (2) a validation engine 612 to determine whether an employee request for resource allocation is valid, (3) an API coordinator 614 to synchronize data collection and resource allocation across multiple systems in the enterprise, and (4) a policy monitor 616 to determine compliance with Data Loss Prevention (DLP) policies and to revoke resource allocations when an employee is not in compliance. The thresholds 610 may be set by a system administrator, an owner of the data, or both. The thresholds 610 may determine what resources (e.g., perks) may be allocated based on the usage data collection permissions. For example, one of the thresholds 610 may specify that to be granted access to database X (e.g., payroll database) that includes sensitive information, the threshold includes employee consent to the collection of A (e.g., email usage data), B (e.g., communications usage data), and C (e.g., firewall usage data). The validation engine 612 may determine whether the thresholds 610 have been satisfied. If the thresholds 610 are satisfied, then the validation engine 612 may instruct the API coordinator 614 to initiate collection of particular usage data for an employee and provide the employee with access to particular corporate resources. For example, the validation engine 612 may determine that a particular employee has consented to the collection of A (e.g., email usage data), B (e.g., communications usage data), and C (e.g., firewall usage data). In response, the validation engine 612 may instruct the API coordinator 614 to interface with the corresponding APIs (e.g., an email usage API, a communications usage API, and a firewall usage API) to initiate collection of A, B, and C for the particular employee. The validation engine 612 may instruct the API coordinator 614 to access the appropriate APIs (e.g., a database access API) to grant the particular employee access to database X (e.g., a payroll database). If the thresholds 610 are not satisfied, then the validation engine 612 may cause a message to be displayed indicating which particular employee consents are to be provided for the employee to be provided with access to the particular corporate resource (e.g., database X).

The policy monitor 616 may monitor employee access to corporate resources to determine compliance with corporate data loss policies etc. The policy monitor 616 may revoke a particular employee's access if the perk that provides access is being used inappropriately. For example, an employee may be granted access to a payroll database that includes confidential information, such as salary information, social security numbers, etc. If the employee's email usage data or communications usage data indicates that salary information or social security numbers are being communicated inappropriately, e.g., to individuals external to the corporation, then the employee's access to the payroll database may be revoked.

For common resources, such as access to particular files or system resources, the broker application 608 may use system API's to grant (or deny) the employee access to the particular files or system resources. Furthermore, many enterprise products (e.g., Microsoft® Exchange, Lync®, etc.) may provide access to specific application features through application policies or API's that can be automatically accessed and set by the broker application 608 in response to employee changes to usage data collection.

The perks (e.g., access to corporate resources) that are provided in exchange for employee permission to collect certain types of data may be implemented in several different ways. For example, particular resource allocations may be associated with permission to collect particular types of usage data. To illustrate, an enterprise may provide a user with the ability to phone internationally using a company supplied phone in exchange for permission to collect call data from the phone. In some cases, the enterprise may determine which resources are allocated in exchange for permission to collect particular types of usage data. In other cases, the employee may request which resources are allocated in exchange for permission to collect particular types of usage data. The validation engine 612 may grant the employee request if the permission and the request satisfy one or more policies specified by the enterprise.

The way in which perks are provided to employees may be implemented in several different ways. For example, the perks provided may be set by an administrator. To illustrate, the administrator may use the APCC 128 to specify that perk X (e.g., access to corporate resource A) is automatically provided when an employee consents to the collection of data in usage category Y. In some cases, the administrator may associate a set of perks with collection of a usage category and enable the employee to select one perk from among the set of perks. For example, the administrator may use the APCC 128 to specify that perks X, Y, and Z are associated with the collection of data in usage category Y and the employee can select one of the perks X, Y, or Z (e.g., access to corporate resource A, resource B, or resource C) as a reward for providing permission to the collection of data in usage category Y. The administrator may provide a set of perks (e.g., without associating the perks with a usage category) and enable the employee to select one perk from among the set of perks based on the number of usage categories to which the employee provides consent. For example, the administrator may use the APCC 128 to specify that perks X, Y, and Z (e.g., access to corporate resource A, resource B, or resource C) are available and that the employee may select N perks (N>0) for consenting to the collection of M (M>0) usage categories. As an example of N=1, M=1, the employee may use the EPMP 130 to consent to the collection of a particular one of the usage category 508. In response, the EPMP 130 may enable the employee to select one of the perks X, Y, or Z. As an example of N=1, M=2, the employee may use the EPMP 130 to consent to the collection of two usage categories (e.g., cloud and BYOD). In response, the EPMP 130 may enable the employee to select one of the perks X, Y, or Z. As an example of N=2, M=1, the employee may use the EPMP 130 to consent to the collection of a particular one of the usage category 508. In response, the EPMP 130 may enable the employee to select two of the perks X, Y, or Z. Of course, any combination of the previously described examples may be used. For example, the administrator may determine a single perk provided to the employee for consenting to the collection of device usage data while providing the employee with the ability to select one perk from a set of four perks for consenting to the collection of cloud usage data.

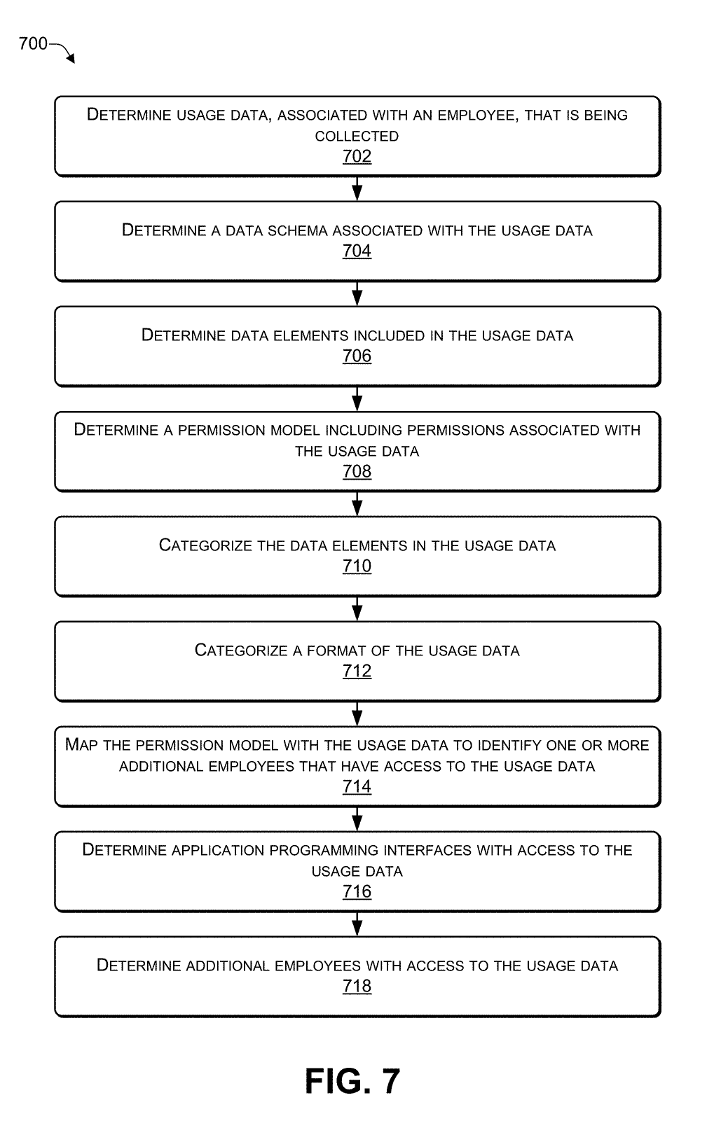

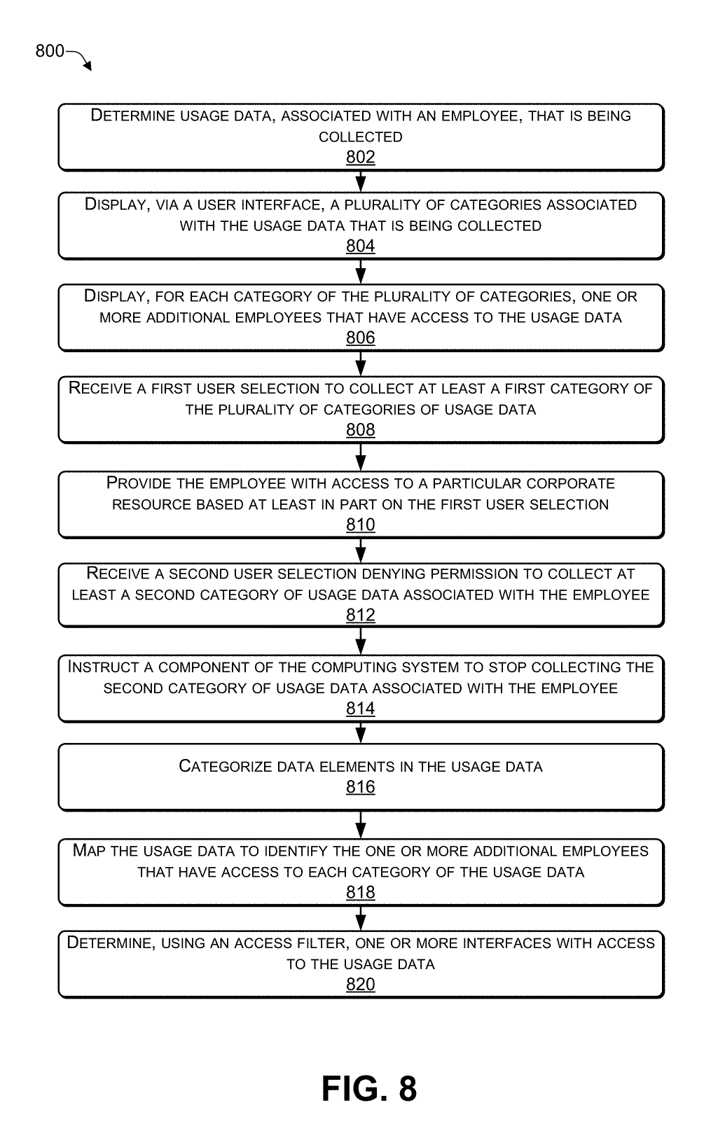

In the flow diagrams of FIGS. 7 and 8, each block represents one or more operations that can be implemented in hardware, software, or a combination thereof. In the context of software, the blocks represent computer-executable instructions that, when executed by one or more processors, cause the processors to perform the recited operations. Generally, computer-executable instructions include routines, programs, objects, modules, components, data structures, and the like that perform particular functions or implement particular abstract data types. The order in which the blocks are described is not intended to be construed as a limitation, and any number of the described operations can be combined in any order and/or in parallel to implement the processes. For discussion purposes, the processes 700 and 800 are described with reference to FIGS. 1, 2, 3, 4, 5, and 6 as described above, although other models, frameworks, systems and environments may implement these processes.

FIG. 7 is a flowchart of a process 700 that includes categorizing data elements in usage data according to some examples. The process 700 may be performed by the data collector 118 of FIGS. 1, 2, and 3.

At 702, usage data associated with an employee that is being collected may be determined. At 704, a data schema associated with the usage data may be determined. At 706, data elements included in the usage data may be determined. For example, in FIG. 2, the data collector 118 may send requests (e.g., to components in the enterprise system 102 of FIG. 1) to determine the usage data 120, such as the event logs 202 and the other data 204, that are being collected. The data collector 118 may determine the data schemas 206 associated with the different types of usage data 120 that is being collected. In some cases, one or more of the schemas 208, 210, 212, 214, or 216 may be provided when the data collector 118 is installed. The data collector 118 may, as part of a discovery process, send queries to different components requesting one or more of the schemas 208, 210, 212, 214, or 216. The data collector 118 may use one or more of the schemas 208, 210, 212, 214, or 216 to determine the schema of a particular type of the usage data 108. For example, the data collector 118 may have the communications data schema 214 associated with a Cisco® IP telephony system and may use the communications data schema 214 to determine the data schema associated with an Avaya® IP telephony system. The data collector 118 may use the schemas 206 to determine the data elements included in the usage data. For example, one of the event logs 202 may be generated when an employee performs a login to a computing device (e.g., workstation). The login event log may include multiple data elements, such as a data element including a device identifier of the computing device, a data element including at least a portion of the credentials (e.g., username, password) used to perform the login, a data element describing the network location of the computing device, a data element describing the physical location of the computing device, a data element including a timestamp identifying when the login took place, etc. In this example, the data element including the credentials may include personally identifiable information, e.g. the username.

At 708, a permission model, including permissions associated with the usage data, may be determined. For example, in FIG. 2, the data collector 118 may determine the permission model 224, e.g., which groups (e.g., supervisor group, manager group, payroll group, human resources group, etc.) have access to which usage data.

At 710, the data elements in the usage data may be categorized. For example, in FIG. 2, the data collector 118 may categorize the usage data 120 to create the categorized data 218(1) to 218(N) for each employee usage profile. To illustrate, data elements in the usage data may be categorized into one of operational data, activity data, identity data, or content data. The operational data may include a server hop a timestamp, a storage quota, a quality of service metric, another type of operational data, or any combination thereof. The activity data may include data associated with a use of a system resource, data associated with use of a software feature, or both. The identity data may include a user identity associated with a directory service, a participant identity of a participant in a communication, domain identity data associated with a domain, another type of identity data, or any combination thereof. The content data may include email content, email attachments, an audio conference recording, a video conference recording, another type of content, or any combination thereof.

At 712, a format of the usage data may be categorized. For example, as illustrated in FIG. 3, the usage data 120 may be categorized into the device usage data 320, the network usage data 324, the firewall usage data 328, the cloud usage data 332, the BYOD usage data 336, the data access information 340, the application usage data 344, and other resource usage data 348.

At 714, the permission model may be mapped to the usage data to identify one or more additional employees that have access to the usage data. For example, in FIG. 2, the permission model 224 (e.g., which groups have access to which data, who belongs to each group, etc.) may be used to identify one or more additional employees (e.g., manager, supervisor, etc.) with access to each employee's usage data.

At 716, one or more APIs with access to the usage data may be determined. For example, in FIG. 3, the data collector 118 may determine one or more interfaces 226 (e.g., application programming interfaces (APIs) or other interfaces) that enable other systems to access the usage data 120.

At 718, additional employees with access to the usage data may be determined. For example, in FIG. 2, additional employees in the corporation with access to each employee usage profile 126 may be determined based on mapping the permission model 224 and based on determining who has access using the one or more interfaces 226. In some cases, a particular employee may have access to a particular category of data. For example, in FIG. 5, the employee may click on the more information 510 for each category to determine which employee has access to each of the usage categories 508. To illustrate, a supervisor may access to the device usage category and the application usage category. A system administrator may have access to the network usage data, firewall usage data, and cloud usage data. A senior manager may have access to the BYOD usage category.

FIG. 8 is a flowchart of a process 800 that includes displaying additional employees that have access to usage data according to some examples. The process 800 may be performed by the employee privacy management portal 130 of FIGS. 1, 2, and 6.

At 802, a determination may be made as to the usage data (e.g., associated with an employee's use of corporate resources) that is being collected in a computing system. For example, in FIG. 2, the data collector 118 may send requests (e.g., to components in the enterprise system 102 of FIG. 1) to determine the usage data 120, such as the event logs 202 and the other data 204, that are being collected. The data collector 118 may determine the data schemas 206 associated with the different types of usage data 120 that is being collected. In some cases, one or more of the schemas 208, 210, 212, 214, or 216 may be provided when the data collector 118 is installed. The data collector 118 may, as part of a discovery process, send queries to different components requesting one or more of the schemas 208, 210, 212, 214, or 216. The data collector 118 may use one or more of the schemas 208, 210, 212, 214, or 216 to determine the schema of a particular type of the usage data 108. For example, the data collector 118 may have the communications data schema 214 associated with a Cisco® IP telephony system and may use the communications data schema 214 to determine the data schema associated with an Avaya® IP telephony system. The data collector 118 may use the schemas 206 to determine the data elements included in the usage data. For example, one of the event logs 202 may be generated when an employee performs a login to a computing device (e.g., workstation). The login event log may include multiple data elements, such as a data element including a device identifier of the computing device, a data element including at least a portion of the credentials (e.g., username, password) used to perform the login, a data element describing the network location of the computing device, a data element describing the physical location of the computing device, a data element including a timestamp identifying when the login took place, etc. In this example, the data element including the credentials may include personally identifiable information, e.g. the username.

At 804, a user interface may be used to display a plurality of categories associated with the usage data that is being collected. For example, in FIG. 6, the EPMP 130 may be used to display, for each employee, usage data in the usage categories 508, such as a device usage category, a network usage category, a firewall usage category, a cloud resources usage category, a BYOD usage category, a data access usage category, an application usage category, and at least one other type of usage category.

At 806, for each category of the plurality of categories, one or more additional employees that access to the usage data may be displayed. For example, in FIG. 6, an employee may select the more information 510 to view the additional employees (e.g., determined based on the permission model 224 and the interfaces 226 of FIG. 2) that have access to each of the usage categories 508.

At 808, a first user selection indicating permission to collect at least a first category of the plurality of categories of usage data may be received. At 810, the employee may be provided with access to a particular corporate resource based at least in part on the first user selection. For example, in FIG. 6, an employee may provide consent to the collection of a particular usage category for usage categories where consent requested 604 is “yes” and may confirm consent in the appropriate entry of the confirm column 606. In response, the broker application 608 may instruct the appropriate network component to initiate collection of that particular category of usage data for the employee and may instruct the appropriate network component to provide a particular perk (e.g., access to a corporate resource) for the employee.

At 812, a second user selection denying permission to collect at least a second category of usage data associated with the employee may be received. At 814, a component of the computing system may be instructed to stop collecting the second category of usage data associated with the employee. For example, in FIG. 6, an employee may deny permission to the connection of a particular usage category for usage categories where consent requested 604 is “yes” and may confirm that permission is denied in the appropriate entry of the confirm column 606. In response, the broker application 608 may instruct the appropriate network component to stop collection of the particular usage data category for the employee. In some cases (e.g., the employee had previously provided consent but is now withdrawing consent), the broker application 608 may instruct the appropriate network component to not provide a particular perk (e.g., prevent access to a particular corporate resource) for the employee.

At 816, data elements in the usage data may be categorized (e.g., into operation data, activity data, identity data, or content data). For example, an event log (e.g., login event log) that is generated and collected when an employee login occurs may include multiple fields. Each field of the event log may be a data element of the usage data associated with the login event. In the login event log, a timestamp data element when the login occurred may be categorized as operation data. The login event log may include a “workstation login” data element identifying the activity that occurred, which may be categorized as activity data. The login event log may include a username data element (e.g., part of the credentials the employee used to perform the login) which may be categorized as identity data.

At 818, the usage data may be mapped (e.g., using a permission model) to identify one or more additional employees that have access to each category of the usage data. For example, in FIG. 2, the usage data 120 may be mapped using the permission model 224 to determine which employees have access to each category of the usage data for each employee.

At 820, an access filter may be used to determine one of more interfaces (e.g., APIs) with access to the usage data. For example, the data collector 118 may determine the interfaces 226 that enable other enterprise systems to access the usage data 120.

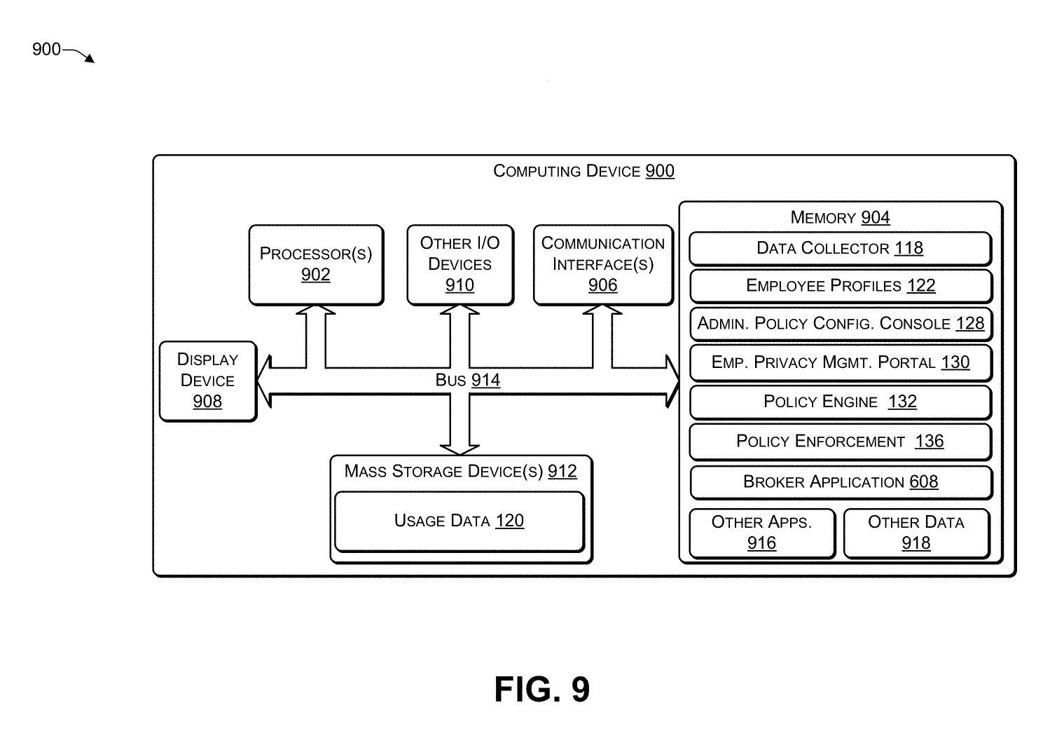

FIG. 9 illustrates an example configuration of a computing device 900 that can be used to implement the systems and techniques described herein, such as one or more components of the enterprise system 102 of FIG. 1. The computing device 900 may include one or more processors 902, a memory 904, communication interfaces 906, a display device 908, other input/output (I/O) devices 910, and one or more mass storage devices 912, configured to communicate with each other, such as via a system bus 914 or other suitable connection.

The processor 902 is a hardware device (e.g., an integrated circuit) that may include one or more processing units, at least some of which may include single or multiple computing units or multiple cores. The processor 902 can be implemented as one or more hardware devices, such as microprocessors, microcomputers, microcontrollers, digital signal processors, central processing units, state machines, logic circuitries, and/or any devices that manipulate signals based on executing operational instructions. Among other capabilities, the processor 902 can be configured to fetch and execute computer-readable instructions stored in the memory 904, mass storage devices 912, or other computer-readable media.

Memory 904 and mass storage devices 912 are examples of computer storage media (e.g., memory storage devices) for storing instructions which are executed by the processor 902 to perform the various functions described above. For example, memory 904 may generally include both volatile memory and non-volatile memory (e.g., RAM, ROM, or the like) devices. Further, mass storage devices 912 may include hard disk drives, solid-state drives, removable media, including external and removable drives, memory cards, flash memory, floppy disks, optical disks (e.g., CD, DVD), a storage array, a network attached storage, a storage area network, or the like. Both memory 904 and mass storage devices 912 may be collectively referred to as memory or computer storage media herein, and may be a media capable of storing computer-readable, processor-executable program instructions as computer program code that can be executed by the processor 902 as a particular machine configured for carrying out the operations and functions described in the implementations herein.

The computing device 900 may also include one or more communication interfaces 906 for exchanging data (e.g., via the network 108 of FIG. 1). The communication interfaces 906 can facilitate communications within a wide variety of networks and protocol types, including wired networks (e.g., Ethernet, DOCSIS, DSL, Fiber, USB etc.) and wireless networks (e.g., WLAN, GSM, CDMA, 802.11, Bluetooth, Wireless USB, cellular, satellite, etc.), the Internet, and the like. Communication interfaces 906 can also provide communication with external storage (not shown), such as in a storage array, network attached storage, storage area network, or the like.

A display device 908, such as a monitor may be included in some implementations for displaying information and images to users. Other I/O devices 910 may be devices that receive various inputs from a user and provide various outputs to the user, and may include a keyboard, a remote controller, a mouse, a printer, audio input/output devices, and so forth.

The computer storage media, such as memory 904 and mass storage devices 912, may be used to store software and data. For example, the computer storage media may be used to store the data collector 118, the employee usage profiles 126, the APCC 128, the EPMP 130, the policy engine 132, the policy enforcement module 136, the broker application 608, other software applications 106 and other data 108.

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

Furthermore, this disclosure provides various example implementations, as described and as illustrated in the drawings. However, this disclosure is not limited to the implementations described and illustrated herein, and can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

Software modules include one or more of applications, bytecode, computer programs, executable files, computer-executable instructions, program modules, code expressed as source code in a high-level programming language such as C, C++, Perl, or other, a low-level programming code such as machine code, etc. An example software module is a basic input/output system (BIOS) file. A software module may include an application programming interface (API), a dynamic-link library (DLL) file, an executable (e.g., .exe) file, firmware, and so forth.

Processes described herein may be illustrated as a collection of blocks in a logical flow graph, which represent a sequence of operations that can be implemented in hardware, software, or a combination thereof. In the context of software, the blocks represent computer-executable instructions that are executable by one or more processors to perform the recited operations. The order in which the operations are described or depicted in the flow graph is not intended to be construed as a limitation. Also, one or more of the described blocks may be omitted without departing from the scope of the present disclosure.

Although various examples of the method and apparatus of the present disclosure have been illustrated herein in the Drawings and described in the Detailed Description, it will be understood that the disclosure is not limited to the examples disclosed, and is capable of numerous rearrangements, modifications and substitutions without departing from the scope of the present disclosure.

What is claimed is:

1. A computer-implemented method, comprising:
determining usage data that is being collected in a computing system, the usage data generated based at least in part on an employee using at least one resource of one or more resources of the computing system;
displaying via a user interface, a plurality of categories associated with the usage data that is being collected;
displaying, via the user interface, for each category of the plurality of categories, one or more additional employees that have access to the usage data;
receiving a first user selection to collect at least a first category of the plurality of categories of usage data; and
providing the employee with access to a first corporate resource based at least in part on receiving the first user selection.

2. The computer-implemented method of claim 1, further comprising:
instructing a first component of the computing system to collect the first category of usage data associated with the employee.

3. The computer-implemented method of claim 1, further comprising:
receiving a second user selection denying permission to collect at least a second category of usage data associated with the employee; and
instructing a component of the computing system to stop collecting the second category of usage data associated with the employee.

4. The computer-implemented method of claim 1, further comprising:
categorizing, using a first filter, the data elements in the usage data into one of operational data, activity data, identity data, or content data;
wherein the operational data includes at least one of a server hop, a timestamp, a storage quota, or a quality of service metric;
wherein the activity data includes at least one of a use of a system resource or use of a software feature;
wherein the identity data includes at least one of a user identity associated with a directory service, a participant identity of a participant in a communication, or domain identity data associated with a domain; and
wherein the content data includes email content, email attachments, an audio conference recording, or a video conference recording.

5. The computer-implemented method of claim 1, further comprising:
mapping, using a permission mapping filter, based at least in part on the data schema and the permission model, the usage data to identify the one or more additional employees that have access to the usage data.

6. The computer-implemented method of claim 1, wherein the plurality of categories including system usage data, activity data, identity data, content data, raw data that includes personally identifiable data, aggregated data that does not include personally identifiable data, anonymized data that does not include personally identifiable data, a combination of anonymized and aggregated data used to determine personally identifiable data, user access information, and third party application access.

7. The computer-implemented method of claim 1, wherein the usage data that is being collected includes one of email usage data, conferencing usage data, software application usage data, or communications usage data.

8. One or more non-transitory computer-readable media storing instructions that are executable by one or more processors to perform operations comprising:
determining usage data that is being collected in a computing system, the usage data generated based at least in part on an employee using at least one resource of one or more resources of the computing system;
displaying via a user interface, a plurality of categories associated with the usage data that is being collected;
displaying, via the user interface, for each category of the plurality of categories, one or more additional employees that have access to the usage data;
receiving a first user selection to collect at least a first category of the plurality of categories of usage data; and
providing the employee with access to a first corporate resource based at least in part on receiving the first user selection.

9. The one or more non-transitory computer-readable media of claim 8, the operations further comprising:
instructing a first component of the computing system to collect the first category of usage data associated with the employee.

10. The one or more non-transitory computer-readable media of claim 8, the operations further comprising:
receiving a second user selection denying permission to collect at least a second category of usage data associated with the employee; and
instructing a component of the computing system to stop collecting the second category of usage data associated with the employee.

11. The one or more non-transitory computer-readable media of claim 8, the operations further comprising:
categorizing, using a first filter, the data elements in the usage data into one of operational data, activity data, identity data, or content data;
wherein the operational data includes at least one of a server hop a timestamp, a storage quota, or a quality of service metric;
wherein the activity data includes at least one of a use of a system resource or use of a software feature;
wherein the identity data includes at least one of a user identity associated with a directory service, a participant identity of a participant in a communication, or domain identity data associated with a domain; and
wherein the content data includes email content, email attachments, an audio conference recording, or a video conference recording.

12. The one or more non-transitory computer-readable media of claim 8, the operations further comprising:
mapping, using a permission mapping filter, based at least in part on the data schema and the permission model, the usage data to identify the one or more additional employees that have access to the usage data.

13. The one or more non-transitory computer-readable media of claim 8, wherein the plurality of categories including system usage data, activity data, identity data, content data, raw data that includes personally identifiable data, aggregated data that does not include personally identifiable data, anonymized data that does not include personally identifiable data, a combination of anonymized and aggregated data used to determine personally identifiable data, user access information, and third party application access.

14. A server comprising:
one or more processors; and
one or more non-transitory computer-readable media storing instructions that are executable by the one or more processors to:
determining usage data that is being collected in a computing system, the usage data generated based at least in part on an employee using at least one resource of one or more resources of the computing system;
displaying via a user interface, a plurality of categories associated with the usage data that is being collected;
displaying, via the user interface, for each category of the plurality of categories, one or more additional employees that have access to the usage data;
receiving a first user selection to collect at least a first category of the plurality of categories of usage data; and
providing the employee with access to a first corporate resource based at least in part on receiving the first user selection.

15. The server of claim 14, the operations further comprising:
instructing a first component of the computing system to collect the first category of usage data associated with the employee.

16. The server of claim 14, the operations further comprising:
receiving a second user selection denying permission to collect at least a second category of usage data associated with the employee; and
instructing a component of the computing system to stop collecting the second category of usage data associated with the employee.

17. The server of claim 14, the operations further comprising:
categorizing, using a first filter, the data elements in the usage data into one of operational data, activity data, identity data, or content data;
wherein the operational data includes at least one of a server hop a timestamp, a storage quota, or a quality of service metric;
wherein the activity data includes at least one of a use of a system resource or use of a software feature;
wherein the identity data includes at least one of a user identity associated with a directory service, a participant identity of a participant in a communication, or domain identity data associated with a domain; and
wherein the content data includes email content, email attachments, an audio conference recording, or a video conference recording.

18. The server of claim 14, the operations further comprising:
mapping, using a permission mapping filter, based at least in part on the data schema and the permission model, the usage data to identify the one or more additional employees that have access to the usage data.

19. The server of claim 14, wherein the plurality of categories including system usage data, activity data, identity data, content data, raw data that includes personally identifiable data, aggregated data that does not include personally identifiable data, anonymized data that does not include personally identifiable data, a combination of anonymized and aggregated data used to determine personally identifiable data, user access information, and third party application access.

20. The server of claim 14, wherein the usage data that is being collected in the computing system includes one of email usage data, conferencing usage data, software application usage data, or communications usage data.
